(19) United States
(12) Patent Application Publication
(10) Pub. No.: US 2004/0211585 A1
(43) Pub. Date: Oct. 28, 2004

(54) Flat flexible cable

(76) Inventor: Nicholas Jordan, (US)

Correspondence Address: HEWLETT-PACKARD COMPANY, Intellectual Property Administration, P.O. Box 272400, Fort Collins, CO, 80527-2400, US

(21) Appl. No.: 10/791,884

(22) Filed: Mar. 4, 2004

(30) Foreign Application Priority Data
Mar. 7, 2003 (GB) 0305228.9

(51) Int. Cl. H01B 7/08

(52) U.S. Cl. 174/117 FF

(57) ABSTRACT

A flat flexible cable and method of making the same, the cable having an elongate composite structure comprising: an elongate region of conductive material; an insulative material surrounding the conductive material; first and second elongate flat conductors sandwiching the insulative material surrounding the elongate region of conductive material; and first and second elongate flat insulators on opposite sides of the first and second elongate flat conductors to the insulative material surrounding the conductive material, wherein the composite structure is itself flat and foldable without structural damage to the cable or its component parts.

This invention relates to a flat cable, in particular to a flat flexible cable. This invention further relates to method of manufacturing a flat flexible cable

Conventional cables typically have a circular cross-sectional construction which results in a limited bend radius so that such cables are difficult to use in situations where the space available for the cable is limited or where the cable must negotiate a tight tortuous path, for example, in mobile telecommunication applications.

Coaxial cables are a good example of a conventional cable with a circular cross-section. A coaxial cable comprises a central conductor surrounded by an: outer cylindrical conductor with an insulating material therebetween. The central conductor is usually in the form of a solid wire or a plurality of twisted strands of wire. The outer cylindrical conductor is usually in the form of a braided or foil sheet. Typically an outer sheath of insulation is supplied around the outer cylindrical conductor.

Coaxial cables are commonly used when it is necessary to shield an electrical signal for more effective transmission and prevent interference from external noise. The shielding structure of such coaxial cables enables the impedance along the cable to be controlled and maintained. The impedance is determined by the dielectric constant of the insulating material and the relative diameters of the central and outer cylindrical conductors. These properties can be varied to achieve the required impedance of a cable. To maintain a constant impedance along the entire length of the cable, the relative diameters of the central and outer cylindrical conductors need to be constant throughout the length of the cable.

Coaxial cables are used as both signal and electrical interconnects and are typically used in the fields of telecommunications, cable television networks and local area ethernet networks.

It is an object of the present invention to seek to overcome at least one of the disadvantages of conventional cables of circular cross-section.

Accordingly, the present invention provides a flat flexible cable having an elongate composite structure comprising: an elongate region of conductive material; an insulative material surrounding the conductive material; first and second elongate flat conductors sandwiching the insulative material surrounding the elongate region of conductive material; first and second elongate flat insulators on opposite sides of the first and second elongate flat conductors to the insulative material surrounding the conductive material; and a first conductive portion electrically interconnecting the first and second conductors on one side of the structure and a second conductive portion electrically interconnecting the first and second conductors on the opposite side of the structure to provide a coaxial cable, wherein the composite structure is itself flat and foldable without structural damage to the cable or its component parts.

Another aspect of the present invention provides a method of manufacturing a flat flexible cable having an elongate composite structure comprising: providing an elongate region of conductive material; forming a surround of insulative material around the conductive material; locating a first and a second flat conductor either side of the insulative material; providing a first and a second flat insulator on opposite sides of the first and second flat conductors to the insulative material surrounding the conductive material; and providing a first conductive portion to electrically interconnect the first and second flat conductors on one side of the cable and a second conductive portion to electrically interconnect the first and second flat conductors on an opposite side of the cable thereby completing an outer conductive screen, wherein the composite structure is foldable without damage to the cable or its component parts.

In order that the present invention may be more readily understood, embodiments thereof will now be described, by way of example, with reference to the accompanying drawings in which:

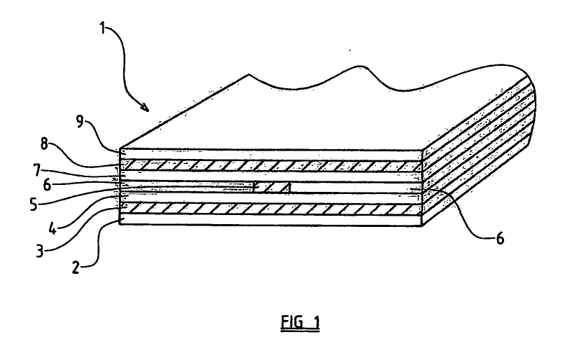

FIG. 1 is a cross-section through a perspective view of a flat cable-having an elongate structure embodying the present invention;

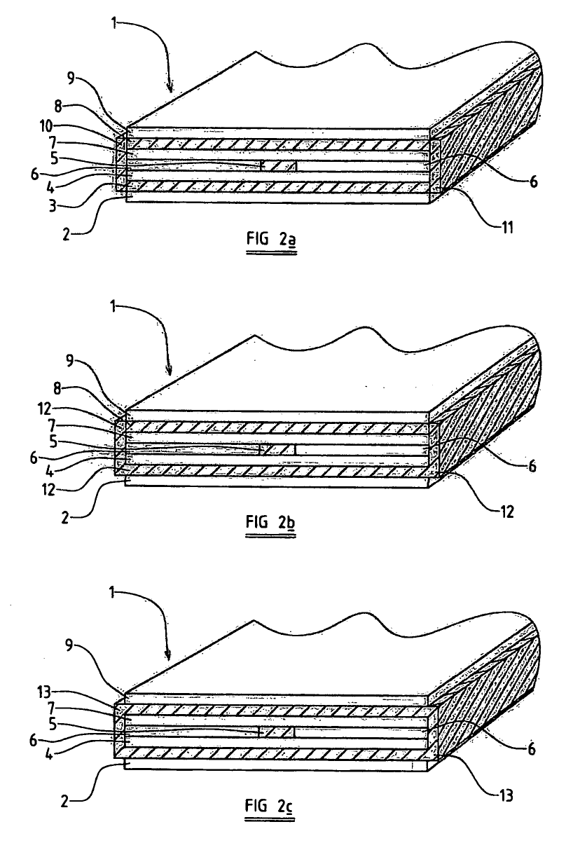

FIG. 2a is a cross-section through a perspective view of the flat cable of FIG. 1 with further features;

FIG. 2b is a cross-section through a perspective view of the flat cable of FIG. 1 with further features;

FIG. 2c is a cross-section through a perspective view of the flat cable of FIG. 1 with further features;

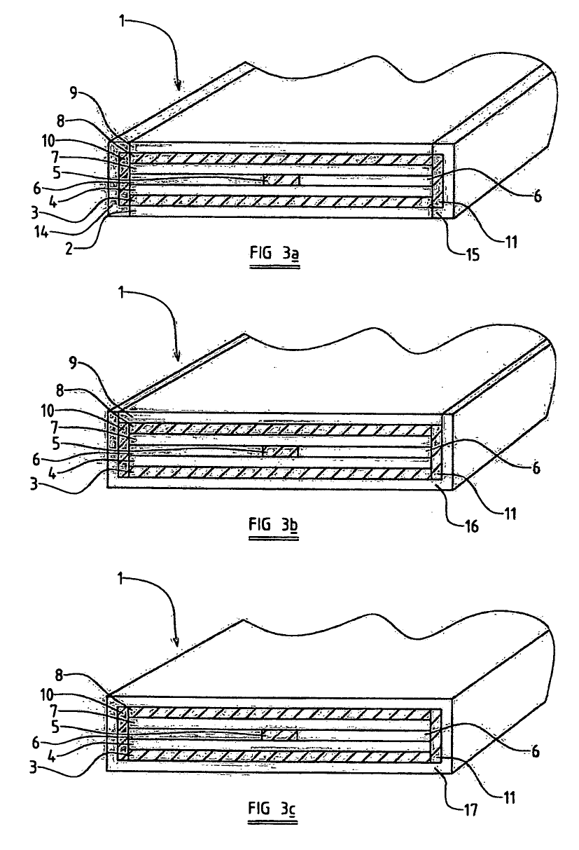

FIG. 3a is a cross-section through a perspective view of the flat cable of FIG. 2a with further features;

FIG. 3b is a cross-section through a perspective view of the flat cable of FIG. 2a with further features;

FIG. 3c is a cross-section through a perspective view of the flat cable of FIG. 2a with further features;

FIG. 4 is a cross-section through a perspective view of the flat cable of FIG. 2c showing a reduced thickness in the first and fifth insulating layers at preselected regions along the cable;

FIG. 5 is a plan view of a length of cable embodying the present invention folded to conform to a required path;

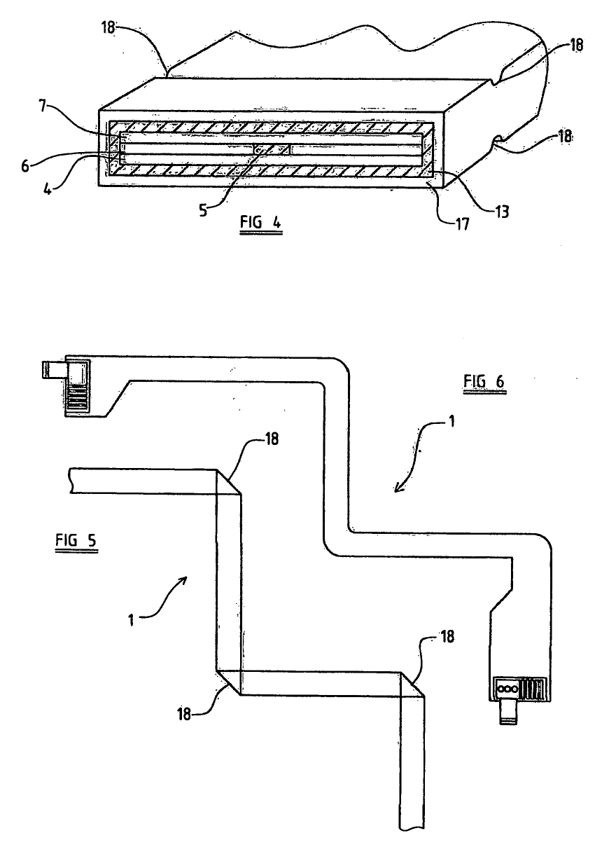

FIG. 6 is a plan view of a terminated cable embodying the present invention formed to conform to a required path;

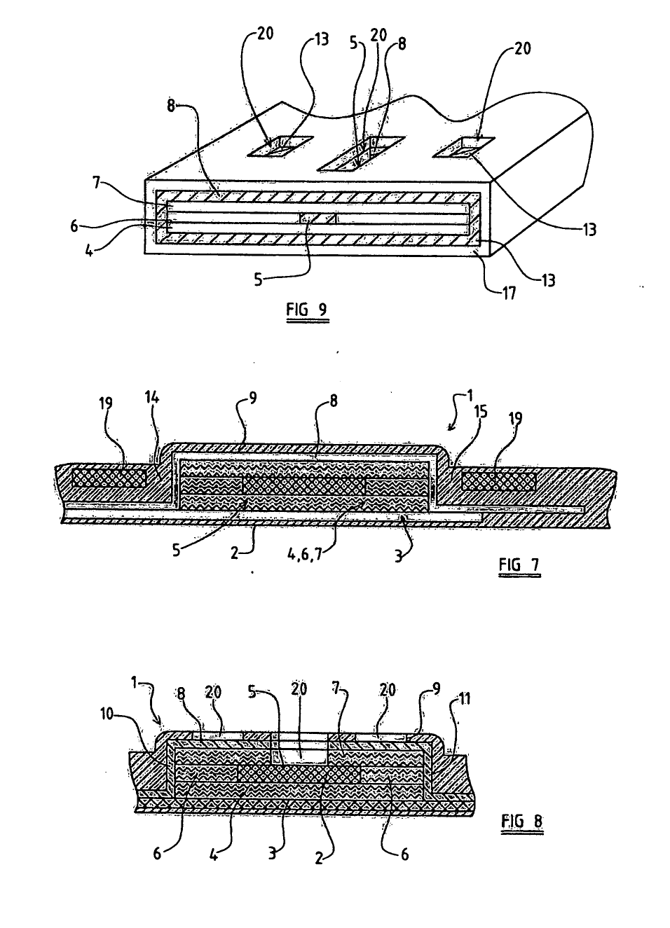

FIG. 7 is a cross-sectional view of a flat cable embodying the present invention;

FIG. 8 is a detail of the cross-sectional view of FIG. 7 with the flat cable being formed with a terminal arrangement; and

FIG. 9 is a cross-section through a perspective view of the flat cable of FIG. 2c showing a terminal arrangement.

A flat cable having an elongate structure is shown in FIG. 1. The flat cable structure is flexible meaning that it can be bent or folded preferably at least through 90° and back on itself without structural damage to the cable or its component parts

The flat cable illustrated in the present Application is a coaxial cable. A coaxial cable has a central conductive core, a surrounding insulative core, an outer conductive screen and an outer insulative sheath.

In the example shown in FIG. 1, the flat cable 1 structure is divided into a multitude of elongate planar layers. The first layer is a first insulative layer 2 composed of an insulative material which is for example polyamide or polyester or any other suitable insulative material. The first insulative layer comprises a part of an outer insulative sheath. The second layer is a first conductive layer 3, positioned adjacent to the first insulating layer 2, in the form of a solid foil or mesh which forms part of an outer conductive screen.

The third layer is a second insulative layer 4, laid adjacent to the first conductive layer 3, composed of an insulative material with dielectric properties that provide the necessary propagation characteristics such as a polyamide or polyester. Such insulative material is preferably the same insulative material as the first insulative layer 2 or any other suitable insulative material. The third layer forms part of an insulative core.

The fourth layer is composed of an elongate conductive region 5 positioned adjacent to the second insulative layer 4 and having a width less than the width of the second insulative layer 4, and a pair of insulative strips 6 located on either side of the conductive region 5 and abutting the second insulative layer 4.

The conductive region 5 is a solid core, wire, mesh or combination thereof preferably of copper but could be of any other suitable conductive material. The insulative strips 6 are composed of an insulative material with dielectric properties that provide the necessary propagation characteristics such as a polyamide or polyester or any other suitable insulative material. Preferably, the insulative material of the insulative strips 6, is the same as the insulative material of the second insulative layers 4 or any other suitable insulative material.

The fifth layer of the flat cable 1 structure is a third insulative layer 7, laid adjacent to and upon the conductive region 5 and the insulative strips 6. The third insulative layer 7 is composed of an insulative material with dielectric properties that provide the necessary propagation characteristics such as a polyamide or polyester or any other suitable insulative material. Preferably the insulative material is the same as the insulative material of the second insulative layer 4 and the insulative strips 6. Together with the second insulative layer 4 and the insulative strips 6, the third insulative layer 7 makes up an insulative core surrounding the conductive region 5.

The sixth layer of the structure is a second conductive layer 8 positioned adjacent to the fifth layer, in the form of a solid foil, plate or mesh forming another part of the outer conductive screen.

The seventh layer of the flat cable 1 structure is the fourth insulative layer 9, adjacent to the second conductive layer 8, which is composed of an insulative material. The insulative material is preferably the same as the insulative material of the first and/or second and/or third insulative layers 2,4,7 and/or insulative strips 6 or any other suitable material. The fourth insulative layer 9 comprises a part of the outer insulative sheath.

Referring to FIG. 2a, a first conductive portion 10 is positioned adjacent to the longitudinal common sides of the second, third, fourth, fifth and sixth layers of the flat cable 1 structure, thereby electrically interconnecting the first and second conductive layers 3,8. Similarly, a second conductive portion 11 is positioned adjacent to the longitudinal common sides of the second, third, fourth, fifth and sixth layers of the structure, on the opposite side to the first conductive portion 10, electrically interconnecting the first and second conductive layers 3, 8. Therefore, the first and second conductive layers 3, 8 and the first and second conductive portions 10,11 are electrically connected to one another and complete an outer conductive screen.

The first and second conductive portions 10,11 can be in the form of a solid foil, a sheet, a plate, a mesh or any combination thereof. In FIG. 2a, the first and second conductive portions 10,11 are individual portions. However, it is envisaged that the third conductive layer 8 and at least one of the first and second conductive portions 10,11 are formed together as a single element. In FIG. 2b, the first conductive layer 3 and the first and the second conductive portions 10,11 comprise a single element 12. In FIG. 2c, the first and second, conductive layers 3,8 and the first and second conductive portions 10,11 comprise a single element 13, thereby forming a continuous sheath. The single elements 12,13 can be in the form of a solid foil or a mesh.

As shown in FIG. 3a, first and second insulative portions 14,15 are positioned adjacent to the first and second conductive portions 10,11 respectively. Each insulative portion 14,15 is in contact with the first and fourth insulative layers 2,9, thereby completing the outer insulative sheath. In FIG. 3a, the first and second insulative portions 14,15 are individual portions. However, it is envisaged that the first insulative layer 2 and at least one of the first and second insulative portions 14,15 could comprise a single element. In FIG. 3b, the first insulative layer 2 and the first and the second insulative portions 14,15 comprise a single element 16. In FIG. 3c, the first and fourth insulative layers 2,9 and the first and second insulative portions 14,15 comprise a single element 17, thereby forming a continuous insulating sheath. In this form the flat cable 1 is a flat coaxial cable. The first and second insulative portions 14,15 and/or the single elements 16,17 are composed of an insulative material of preferably the same composition, as discussed above with relation to the first and the fourth insulative layers 2,9.

The assembled conductive and insulative layers and portions making up the cable structure have a combined thickness which is no more than in the order of 1 mm and preferably less than 0.5 mm. The combined thickness can be any suitable thickness which without preventing flexible folding of the cable structure will not cause structural damage to the cable or its component parts. In any case the respective thicknesses of the layers between the first and second conductive layers 3,8 are selected to ensure constant impedance along the cable, the matched transmission system, and to ensure flexibility—i.e. the ability to fold.

To ensure a constant impedance along the entire structure of the flat cable 1, when configured as a co-axial cable, the thickness of the second and third insulative layers 4,7 must remain constant along the entire length of the flat cable 1. Thus, the distance between the conductive region 5 and the first and second conductive layers 3,8 are constant along the length of the cable. The widths of the insulative strips 6, on either side of the conductive region 5 do not have a substantial effect on the impedance of the cable 1.

To accommodate changes in direction in the cable path, the thickness of the first and/or fourth insulative layers 2,9 can be reduced at predetermined locations 18 along the length of the cable 1 to provide fold lines. Since the structure is flat and flexible, it is readily foldable to conform to a required cable path. The foldability of the cable, allowing the cable to bend or fold back on itself, enables the flat coaxial cable to follow a tight tortuous pathway for interconnection solutions where space is restricted. Changes in cable path direction within the same plane can be accommodated in two ways: either by folding the cable over at a desired angle to the longitudinal axis of the cable or by custom manufacturing the cable incorporating the desired changes of direction. For example, FIG. 5 shows a cable which has been folded back on itself along a fold line at 45 degrees to the longitudinal axis of the cable so as to effect a change of direction of 90 degrees and FIG. 6 shows a cable which has been manufactured to incorporate the same change in direction.

The folding characteristics of the flat flexible cable can be enhanced by incorporating preformed fold lines in the cable at pre-designated positions along the length of the cable. The fold lines comprise areas of reduced thickness—reduced thickness areas or lines being easier to fold. The first and fourth insulative layers 2,9 are the layers which are reduced in thickness at pre-designated positions 18 as shown in FIG. 4.

It is envisaged that standard electrical conductors could be intercalated within at least one of the first and fourth insulative layers 2,9 and the first and second insulative portions 14,15. In FIG. 7, flat conductors 19 have been intercalated within the first and second insulative portions 14,15. It would also be possible for a plurality of flat coaxial cables to be formed in a single flat cable each surrounded by a common outer insulative sheath.

Referring again to FIG. 7, the first conductive layer 3 is provided as a substrate upon which are applied the second insulative layer 4, the conductive region 5, the insulative strips 6 and the third insulative layer 7 after which this structure of conductive region, strips and stacked layers 4,5,6,7 are capped with a conductor 8 which lies over and which is pressed down along the side edges of this structure and into contact with the first conductive layer 4 on either side of the structure. The conductor 8 therefore makes up not only the third conductive layer 8 but also the first and second conductive portions 10,11 along the side edges of the structure.

The ends of the flat cable 1 are terminated by standard surface mount technology SMT coaxial connectors or standard low insertion force connectors for connection to standard components, for example standard flat printed circuit boards. It is also possible, due to the flat cable structure, for an opening 20 to be formed through the layers of the cable 1, as shown in FIGS. 8 and 9, that exposes and provides access to the conductive layers 3,8, conductive regions 5 and/or the conductive portions 10,11, thereby creating a terminal arrangement in the form of a land pattern to which a connector can be bonded or indeed, to enable components such as a printed circuit: board to be directly connected the flat cable 1, a feature which would be advantageous in an application with limited space.

Preferably, the opening or openings 20 creating a land pattern are formed through the insulative and/or conductive layers and/or portions by an etching process, thereby providing a terminal consisting of an exposed conductive surface of a conductive layer, region or portion. Alternatively, the opening or openings 20 are formed through the insulative and/or conductive layer, region and/or portion by mechanical drilling or any other suitable method.

The provision of the land pattern by the use of openings down to the conductive layers 3,8 and conductive region 5, is especially advantageous in view of the planar nature of the cable offering distinct advantages over a conventional circular section cable. The terminated cable in the form of a coaxial cable also provides a matched transmission system.

The material for the insulative layers is preferably a flexible polyamide or polyester having the required dielectric constant but for applications where no folding is required, more rigid materials can be used such as a glass fibre laminate, for example FR4 or any other suitable material.

A flat cable 1 is preferably constructed by consecutively stacking respective layers one on top of the other and adjacent one another. Layers in the cable structure are provided by chemical deposition, a mask and etch process or by producing a layer as a distinct element e.g. a length of foil. Other processes can be used which do not require layers to be stacked consecutively, for instance by preforming an insulated core comprising the conductive region 5 and its surrounding insulator and subsequently sandwiching that arrangement to produce a flat structure. Any other suitable construction methods may also be used to produce the flat cable structure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A flat flexible cable having an elongate composite structure comprising:
an elongate region of conductive material;
an insulative material surrounding the conductive material;
first and second elongate flat conductors sandwiching the insulative material surrounding the elongate region of conductive material;
first and second elongate flat insulators on opposite sides of the first and second elongate flat conductors to the insulative material surrounding the conductive material; and
a first conductive portion electrically interconnecting the first and second conductors on a one side of the structure and a second conductive portion electrically interconnecting the first and second conductors on an opposite side of the structure to provide a coaxial cable, wherein the composite structure is itself flat and foldable without structural damage to the cable or its component parts.

2. A flat cable according to claim 1, wherein one of the first and second conductors and at least one of the first and second conductive portions comprise a single element.

3. A flat cable according to claim 2, wherein the single element is a conductive foil.

4. A flat cable according to claim 1, further comprising a first and a second insulative portion, positioned adjacent to the first and second conductive portions respectively, each insulative portion being in contact with the first and second flat insulators.

5. A flat cable according to claim 4, wherein the first flat insulator and at least one of the first and second insulative portions comprise a single element.

6. A flat cable according to claim 4, wherein a single insulative element comprises the first and second flat insulators and the first and second insulative portions.

7. A flat cable according to claim 1, wherein at least one of the flat conductors, the conductive region and the conductive portions is in the form of a foil.

8. A flat cable according to claim 1, wherein at least one of the flat conductors, the conductive region and the conductive portions is in the form of a mesh.

9. A flat cable according to claim 6, further comprising at least one conductor intercalated within the single insulative element.

10. A flat flexible cable having an elongate composite structure comprising:
an elongate region of conductive material;
an insulative material surrounding the conductive material;
first and second elongate flat conductors sandwiching the insulative material surrounding the elongate region of conductive material; and
first and second elongate flat insulators on opposite sides of the first and second elongate flat conductors to the insulative material surrounding the conductive material, wherein the composite structure is itself flat and foldable without structural damage to the cable or its component parts and the insulative material between the conductive region and the respective flat conductors has a thickness which is constant along the length of the cable.

11. A flat flexible cable having an elongate composite structure comprising:
an elongate region of conductive material;
an insulative material surrounding the conductive material;
first and second elongate flat conductors sandwiching the insulative material surrounding the elongate region of conductive material; and first and second elongate flat insulators on opposite sides of the first and second elongate flat conductors to the insulative material surrounding the conductive material, wherein the composite structure is itself flat and foldable without structural damage to the cable or its component parts and at least one of the first and second flat insulators has a thickness which is reduced at a preselected region along the cable.

12. A flat flexible cable having an elongate composite structure comprising:
an elongate region of conductive material;
an insulative material surrounding the conductive material;
first and second elongate flat conductors sandwiching the insulative material surrounding the elongate region of conductive material; and
first and second elongate flat insulators on opposite sides of the first and second elongate flat conductors to the insulative material surrounding the conductive material, wherein the composite structure is itself flat and foldable without structural damage to the cable or its component parts and further comprises at least one terminal contact consisting of a surface exposed by an opening through at least a portion of the cable structure, the surface being part of one of the group consisting of: one of the flat conductors; and the conductive region.

13. A method of manufacturing a flat flexible cable having an elongate composite structure comprising:
providing an elongate region of conductive material;
forming a surround of insulative material around the conductive material;
locating a first and a second flat conductor either side of the insulative material;
providing a first and a second flat insulator on opposite sides of the first and second flat conductors to the insulative material surrounding the conductive material; and
providing a first conductive portion to electrically interconnect the first and second flat conductors on one side of the cable and a second conductive portion to electrically interconnect the first and second flat conductors on an opposite side of the cable thereby completing an outer conductive screen, wherein the composite structure is foldable without damage to the cable or its component parts.

14. A method of manufacturing a flat cable structure according to claim 13, wherein at least some of the component parts are consecutively stacked one on top of the other.

15. A method of manufacturing a flat cable structure according to claim 13, wherein at least one of the component parts is provided by chemical deposition.

16. A method of manufacturing a flat cable structure according to claim 13, wherein an opening is provided through the cable structure to form a terminal consisting of an exposed surface of one of the group consisting of: one of the flat conductors and the conductive material.

17. A method of manufacturing a flat cable structure according to claim 16, wherein the opening is formed by one of the following processes: an etching process and by mechanical drilling.
